(19) United States
(12) Patent Application Publication
(10) Pub. No.: US 2003/0141389 A1
(43) Pub. Date: Jul. 31, 2003

(54) Injection device and method for injecting fluid

(76) Inventor: Friedrich Boecking, Stuttgart (DE)

Correspondence Address: RONALD E. GREIGG, GREIGG & GREIGG P.L.L.C., 1423 POWHATAN STREET, UNIT ONE, ALEXANDRIA, VA, 22314, US

(21) Appl. No.: 10/204,172

(22) PCT Filed: Feb. 16, 2001
(86) PCT No.: PCT/DE01/00585

(30) Foreign Application Priority Data
Feb. 18, 2000 (DE) 100 06 786.7

(51) Int. Cl. B05B 1/30

(52) U.S. Cl. 239/585.1

(57) ABSTRACT

The invention relates to an injection system, having a control valve (2), an actuating element for actuating the control valve (2), an injection nozzle which is controllable by the control valve (2) via a pressure buildup or pressure reduction in a control chamber (8), wherein the control valve (2) has at least two switching states, and in a first switching state of the control valve (2), a first pressure is established in the control chamber (8), at which pressure the injection nozzle is closed, and in a second switching state of the control valve (2), a second pressure is established in the control chamber (8), at which the injection nozzle is opened, wherein the control valve (2) has at least one third switching state, in which a third pressure is established in the control chamber (8), which pressure is between the first pressure and the second pressure and at which the injection nozzle is opened. The invention also relates to a method for injecting fluid in which the injection system of the invention is used.

### PRIOR ART

The invention relates to an injection system, having a control valve, an actuating element for actuating the control valve, an injection nozzle which is controllable by the control valve via a pressure buildup or pressure reduction in a control chamber, wherein the control valve has at least two switching states, and in a first switching state of the control valve, a first pressure is established in the control chamber, at which pressure the injection nozzle is closed, and in a second switching state of the control valve, a second pressure is established in the control chamber, at which the injection nozzle is opened. The invention also relates to a method for injecting fluid in which an actuating element is triggered electrically, the actuating element actuates a control valve, as a result of the actuation of the control valve a pressure is built up or reduced in a control chamber, and the injection nozzle opens or closes as a function of the pressure in the control chamber.

An apparatus and a method of these generic types are known and are preferably used in storage-type (“common rail”) injection systems. In common rail injection, the generation of pressure and the injection are decoupled from one another. The injection pressure is generated independently of the engine rpm and of the injection quantity and is available in the rail (fuel reservoir) for injection. The instant of injection and the injection quantity are calculated in an electronic control unit and are converted by the injection system at each engine cylinder via a triggered actuating element. As actuating elements, magnet valves and piezoelectric actuators are generally used. Thus the injection system can be supplied practically continuously with the pressure from the common rail, at a level of 1000 to 2000 bar, for instance. This high fluid pressure is then used on the one hand to perform an injection at high injection pressure, where a high pressure has a positive effect on pollutant emissions and fuel consumption. On the other, the fluid is also used for stroke-controlled operation of the system.

It is fundamentally avoidable, in stroke- controlled injection systems, that a certain proportion of the fluid must be diverted into a leak fuel system. This leak fuel system then generally communicates with a fuel tank, so that the leak fuel quantity can be returned from the injection system to the fuel tank. It is generally desirable for the incident leak fuel quantities to be reduced, since they lower the efficiency of the injection system and also cause further disadvantages, for instance in terms of the power demands made of the high-pressure pump.

In the injection system of the generic type in question, leak fuel quantities occur at multiple points and during a plurality of functional states of the system. For example, the pressure chamber of the injection nozzle communicates, among other ways via the guidance of the pressure rod of the injection nozzle, with the control chamber of the injection system, which preferably is immediately adjacent the pressure rod. If the pressure in the control chamber is reduced in order to relieve the pressure rod and enable opening of the injection nozzle, the result is a major pressure difference between the control chamber, which for the sake of relief communicates with a leak fuel system, and the pressure chamber of the injection nozzle, in which the pressure of the common rail prevails. The result is accordingly an overflow out of the pressure chamber of the injection nozzle into the control chamber and finally into the leak fuel system. The guides of the pressure rod act like an inlet throttle (Z-throttle), which in the pressure-relieved state of the control chamber is an undesirable side effect. Particularly for fast switching operations, throttles (both inlet and outlet throttles) are necessary anyway. It is therefore especially desirable to reduce the leak fuel quantity during the open state of the control valve.

### ADVANTAGES OF THE INVENTION

The injection system of the invention as defined by claim 1 improves on the prior art by providing that the control valve has at least one third switching state, in which a third pressure is established in the control chamber, which pressure is between the first pressure and the second pressure and at which the injection nozzle is opened. In this way, the disadvantages of the prior art are counteracted. If the control chamber is pressure-relieved by the actuation of the control valve, then a high pressure difference between the control chamber and the pressure chamber of the injection nozzle exists. On the one hand, this is desired so that the injection nozzle will open quickly; on the other, it has the disadvantage that large fuel quantities will overflow from the pressure chamber via the guide of the pressure rod of the injection nozzle into the control chamber and finally into the leak fuel system. With the invention, it is now possible on the one hand to assure fast opening of the injection nozzle, specifically because the control chamber is relieved quickly in the usual way, but then in turn to assure a certain pressure buildup in the control chamber. This pressure buildup in the control chamber on the one hand lessens the pressure difference between the control chamber and the pressure chamber of the injection nozzle and consequently reduces the overflow of fluid into the control chamber and into the leak fuel system; on the other hand, however, the pressure can be selected such that the injection nozzle remains in its opened state. It is also advantageous that even before the injection nozzle closes, a certain pressure buildup has occurred in the control chamber, so that the subsequent pressure buildup, which leads to the closure of the injection nozzle, must overcome only a lesser pressure difference, which leads to faster closure of the injection nozzle because of the reduced switching lag.

Preferably, the actuating element is a piezoelectric actuator, which undergoes a change in length as a result of electrical triggering. Piezoelectric actuators have proven themselves in use in injection systems, especially because of their small structure and reliable mode of operation. In the present case, using piezoelectric actuators is especially useful, since their change in length is simple to vary by means of the parameters of the electrical triggering (such as voltage and pulse length).

Preferably, the control valve has a fourth switching state, in which a pressure is established in the control chamber at which the injection nozzle is closed. This can facilitate the cyclical mode of operation of the control valve, especially with a view to shaping the course of injection and with a view to a preinjection.

The invention has particular advantages in an injection system of the kind in which the control chamber is defined partly by one end face of a pressure rod of the injection nozzle. Hence the control chamber is immediately adjacent the pressure rod, which promotes the overflow of fluid from the pressure chamber into the control chamber at an existing pressure difference. Reducing the pressure difference accordingly has an especially pronounced effect in such a system.

Preferably, the pressure rod of the injection nozzle is subjected to force by elastic means. These elastic means, preferably a spiral spring, securely hold the injection nozzle in a defined state.

An especially advantageous refinement of the invention provides that the control valve in the first switching state is located in a first valve seat, so that the control chamber is disconnected from a leak fuel system; that the control valve in the second switching state is not located in a valve seat, so that the control chamber communicates with a leak fuel system via a first flow cross section; and that the control valve in the third switching state is not located in a valve seat, so that the control chamber communicates with a leak fuel system via a second flow cross section, and the first flow cross section is greater than the second flow cross section. By the suitable choice of flow cross sections of the control valve, the pressure buildup in the control chamber can be selected in an especially simple way. For example, the first flow cross section can be the maximum possible flow cross section of the control valve; that is, the control valve is completely open. The second flow cross section is then adjustable continuously between the closed state of the control valve (zero flow cross section) and the completely open state, with a maximum flow cross section. The correct pressure buildup in the second switching state of the control valve can accordingly be ascertained by way of the characteristics of the control valve.

It can be advantageous if the control valve in a fourth switching state is located in a second valve seat, so that the control chamber is disconnected from a leak fuel system. Thus in this variant, the pressure buildup in the control chamber for closing the injection nozzle is effected by the closure of the control valve, although by way of a second valve seat. Given a suitable disposition of the second valve seat, an opening and subsequent closure of the injection nozzle can accordingly be effected by expansion of only the actuating element. A subsequent (partial) cycle is then effected solely by shortening the length.

Preferably, the injection pressure is generated by a common rail. Precisely in this system, where in the pressure chamber the injection nozzle is practically continuously at a high pressure, the invention is useful. The high pressure in the pressure chamber of the injection nozzle results in a high pressure difference between the pressure chamber and the control chamber. Reducing this pressure difference by varying the pressure in the control chamber can at least partly overcome the disadvantages resulting from excessive leak fuel quantities.

The invention defined by claim 9 improves on the method of the generic type in that as a result of the triggering of the actuating element, the control valve is first moved from a first switching state into a second switching state of at least three switching states, as a result of which the pressure in the control chamber is reduced and the injection nozzle opens; that by continued triggering of the actuating element, the control valve is put into a third switching state of at least three switching states, as a result of which a pressure in the control chamber is built up and the injection nozzle remains in the opened state; and that by continued triggering of the actuating element, the control valve is put into a further switching state, in which a pressure in the control chamber is built up more extensively, as result of which the injection nozzle closes. In this way, accordingly after the opening of the injection nozzle, which is effected by a relief of the control chamber, the pressure in the control chamber partly builds up again, without closing the injection nozzle. Thus on the one hand the rapid pressure reduction can be effected, which enables fast opening of the injection nozzle; on the other, the pressure difference between the pressure chamber of the injection nozzle and the control chamber is reduced, and thus the leak fuel quantity is reduced as well.

It can be preferable that the control valve in the first switching state is located in a first valve seat, and that the further switching state is equivalent to the first switching state. Thus to end the injection event, the control valve returns to its outset position in the first valve seat.

Preferably, the control valve in the further switching state is located in a second valve seat. Thus by the reciprocating motion of the control valve between a first and second valve seat and a corresponding interim positioning of the control valve in a partly open state, the advantages of the invention can be realized.

It is preferable that in the first switching state of the control valve and in the further switching state of the control valve, the control chamber is disconnected from a leak fuel system, and that in the second switching state of the control valve and the third switching state of the control valve, the control chamber communicates with the leak fuel system. The pressure relief of the control chamber is thus effected by connecting the control chamber to a leak fuel system, while the pressure buildup takes place by decoupling the control chamber from the leak fuel system.

It is especially preferable that the flow cross section through the control valve in the second switching state of the control valve is greater than in the third switching state of the control valve. The variable pressure establishment in the control chamber is accordingly adjusted via the flow cross section of the control valve.

The invention is based on the surprising finding that the leak fuel quantity of an injection system can be reduced by varying the pressure in the control chamber during the opening phase of the injection nozzle. It has been found that the pressure in the control chamber can be adapted to a considerable extent to the common rail pressure in the pressure chamber of the injection nozzle, so that while on the one hand closure of the injection nozzle does not yet occur, nevertheless a substantially lesser flow of fluid out of the pressure chamber into the control chamber exists.

### DRAWING

The invention will be described in conjunction with the drawing in terms of a special embodiment taken as an example.

FIG. 1 shows a detail, partly in section, of an injection system of the invention;

FIG. 2 shows three graphs to explain the method of the invention;

FIG. 3 shows a graph explaining the invention.

### DESCRIPTION OF THE EXEMPLARY EMBODIMENT

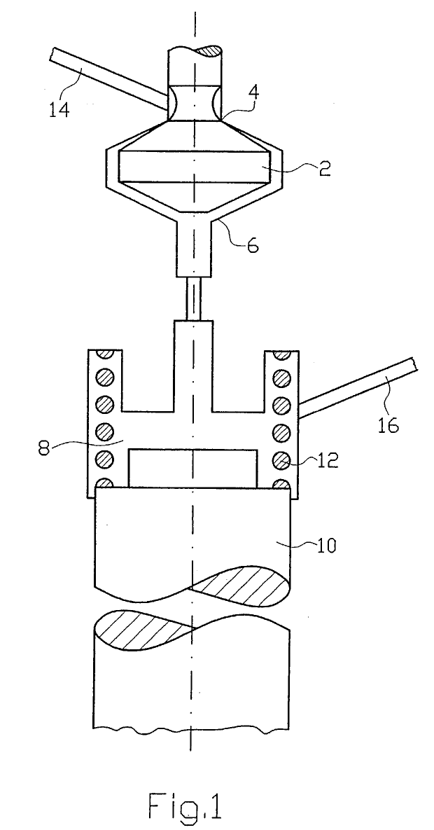

FIG. 1, an injection system of the invention is shown in part. A control valve 2 is actuatable by an actuating element, not shown, which is disposed above the control valve 2. The control valve 2 has a first valve seat 4 and a second valve seat 6. The control valve 2 communicates with a control chamber 8, which is partly defined by the pressure rod 10 of an injection nozzle. The pressure rod 10 is also subjected to force by a spring 12, in order to impart a defined closed position to the injection nozzle. In the state shown, the control valve 2 is located in its first valve seat 4, so that the control chamber 8 is disconnected from a leak fuel system 14, represented schematically by a line. Since the control chamber 8 is in communication with the common rail 16, also represented schematically by a line, in the state shown for the control valve 2, the common rail pressure can develop in the control chamber 8. Consequently, the pressure rod 10 and thus the injection nozzle are pressed downward, which keeps the injection nozzle in a closed state. If the control valve 2, by actuation by the actuating element, then leaves its first valve seat 4, the control chamber 8 is relieved. The pressure rod 10 of the injection nozzle can consequently move upward. The injection nozzle therefore opens.

In the pressure chamber, not shown, of the injection nozzle, common rail pressure prevails practically constantly, and hence this is also true during the injection event. Since during the injection event, however, the control chamber 8 is pressure-relieved, a particularly high pressure difference between the pressure chamber and the control chamber 8 exists in this phase. Fluid can thus reach the control chamber 8 via the guide of the pressure rod 10 and additionally burden the leak fuel system 14. The invention counteracts this effect. When the control chamber 8 is relieved and the pressure rod 10 has consequently moved upward, the control valve 2 is partly closed, so that although the pressure increases further in the control chamber 8, it still remains below the closing pressure of the injection nozzle. The leak fuel flow, promoted by the pressure difference, is accordingly lessened.

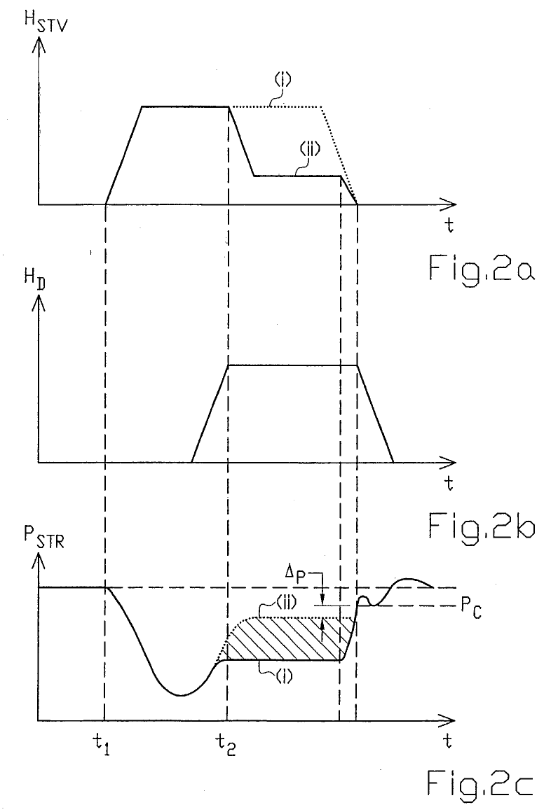

The stroke and pressure conditions in the injection system of the invention will now be explained further in conjunction with FIG. 2. In the top graph (a), the stroke of the control valve H_{STV} is plotted over the time t. In the middle graph (b), the nozzle stroke H_{D} is also plotted over the time t. In the bottom graph (c), the pressure in the control chamber P_{STR} is plotted over the time t. The three graphs (a), (b) and (c) are disposed one above the other in such a way that their time axes t correspond to one another.

Before time t₁, the control valve is in its seat. The stroke of the control valve is zero. Consequently, a high pressure builds up in the control chamber, which causes the nozzle stroke also to be zero. At time t₁, the control valve is then actuated, causing its stroke to be other than zero. Accordingly, the control chamber is relieved. After a certain time lag, the nozzle opens as well. At time t₂, the nozzle is in its fully open state, and extensive relief of the control chamber prevails.

In the upper graph (a) of FIG. 2, the curve (i) shows how the stroke of the control valve in the prior art continues to behave. The control valve is simply kept at its maximal stroke, with the result that the pressure remains at the low value shown, represented by curve (i) in the bottom graph (c) in FIG. 2. Consequently, in the prior art, there is a major pressure difference between the pressure chamber of the injection nozzle and the control chamber.

The course of the stroke of the control valve in the invention is represented in FIG. 2a by curve (ii). After time t₂, the stroke of the control valve is reduced, so that the pressure in the control chamber increases in accordance with FIG. 2c and curve (ii) shown there. However, this increase in pressure occurs only up to a pressure P_{c}−Δₚ, where P_{c} is the closing pressure of the injection nozzle. Consequently, because of the pressure increase in the control chamber, the nozzle stroke does not change, as can be seen from FIG. 2b. Subsequently, the stroke of the control valve is returned to zero; the pressure in the control chamber exceeds the closing pressure P_{c} of the nozzle, and the nozzle stroke consequently returns to the zero value as well.

In the illustration in FIG. 2, it must be noted that in FIG. 2a, the relative stroke of the control valve is in fact shown with respect to its valve seats. If a control valve with two valve seats is used, for instance, then the first trailing edge of the curve (ii) can be brought about by a further motion of the control valve in the original direction or by a reversal of motion.

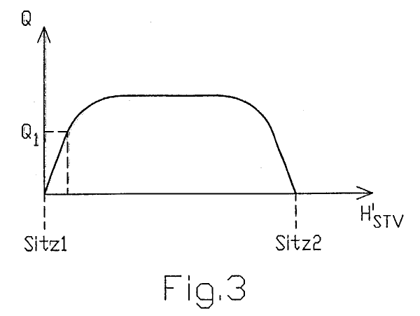

These relationships are shown in further detail again in FIG. 3, in which the flow cross section Q is shown plotted over the absolute stroke H′_{STV}. The variable H′_{STV} is thus the actual stroke of the control valve out of its first valve seat (seat 1), rather than, as in FIG. 2a, the relative stroke with respect to an arbitrary valve seat. It can be seen from FIG. 3 that the flow cross section Q can be adjusted between zero and a maximal value by means of a suitably selected stroke H′_{STV}. By suitable triggering of the actuating element and a corresponding change in length, a suitable stroke H′_{STV} and thus also a suitable flow cross section Q can thus be established. The establishment [setting etc.] of a reduced flow cross section, such as Q₁, then leads to the pressure increase, which in the invention is advantageous, in the control chamber shown in FIG. 2c.

The above description of the exemplary embodiments of the present invention is intended solely for illustrative purposes and not for limiting the scope of the invention. Within the scope of the invention, various changes and modifications can be made without departing from the scope of the invention or its equivalents.

1. An injection system, having a control valve (2), an actuating element for actuating the control valve (2), an injection nozzle which is controllable by the control valve (2) via a pressure buildup or pressure reduction in a control chamber (8), wherein the control valve (2) has at least two switching states, and in a first switching state of the control valve (2), a first pressure is established in the control chamber (8), at which pressure the injection nozzle is closed, and in a second switching state of the control valve (2), a second pressure is established in the control chamber (8), at which the injection nozzle is opened, characterized in that the control valve (2) has at least one third switching state, in which a third pressure is established in the control chamber (8), which pressure is between the first pressure and the second pressure and at which the injection nozzle is opened.

2. The injection system of claim 1, characterized in that the actuating element is a piezoelectric actuator, which undergoes a change in length as a result of electrical triggering.

3. The injection system of claim 1 or 2, characterized in that the control valve (2) has a fourth switching state, in which a pressure is established in the control chamber (8) at which the injection nozzle is closed.

4. The injection system of one of the foregoing claims, characterized in that the control chamber (8) is defined partly by one end face of a pressure rod (10) of the injection nozzle.

5. The injection system of claim 4, characterized in that the pressure rod (10) of the injection nozzle is subjected to force by elastic means.

6. The injection system of one of the foregoing claims, characterized in that the control valve (2) in the first switching state is located in a first valve seat (4), so that the control chamber (8) is disconnected from a leak fuel system (14); that the control valve (2) in the second switching state is not located in a valve seat (4, 6), so that the control chamber communicates with a leak fuel system (14) via a first flow cross section; and that the control valve (2) in the third switching state is not located in a valve seat (4, 6), so that the control chamber (8) communicates with a leak fuel system (14) via a second flow cross section, and the first flow cross section is greater than the second flow cross section.

7. The injection system of one of the foregoing claims, characterized in that the control valve (2) in a fourth switching state is located in a second valve seat (6), so that the control chamber (8) is disconnected from a leak fuel system (8).

8. The injection system of one of the foregoing claims, characterized in that the injection pressure is generated by a common rail (16).

9. A method for injecting fluid, in which an actuating element is triggered electrically, the actuating element actuates a control valve (2), and by the actuation of the control valve (2), a pressure in a control chamber (8) is built up or reduced, and the injection nozzle opens or closes as a function of the pressure in the control chamber (8), characterized in that as a result of the triggering of the actuating element, the control valve (2) is first moved from a first switching state into a second switching state of at least three switching states, as a result of which the pressure in the control chamber (8) is reduced and the injection nozzle opens; that by continued triggering of the actuating element, the control valve (2) is put into a third switching state of at least three switching states, as a result of which a pressure in the control chamber (8) is built up and the injection nozzle remains in the opened state; and that by continued triggering of the actuating element, the control valve (2) is put into a further switching state, in which a pressure in the control chamber (8) is built up more extensively, as result of which the injection nozzle closes.

10. The method of claim 9, characterized in that the control valve (2) in the first switching state is located in a first valve seat (4), and that the further switching state is equivalent to the first switching state.

11. The method of claim 9, characterized in that the control valve (2) in the further switching state is located in a second valve seat (6).

12. The method of one of claims 9-11, characterized in that in the first switching state of the control valve (2) and in the further switching state of the control valve (2), the control chamber (8) is disconnected from a leak fuel system (14), and that in the second switching state of the control valve (2) and the third switching state of the control valve (2), the control chamber (8) communicates with the leak fuel system (14).

13. The method of one of claims 9-12, characterized in that the flow cross section through the control valve (2) in the second switching state of the control valve (2) is greater than in the third switching state of the control valve (2).
